(19) United States
(12) Patent Application Publication
(10) Pub. No.: US 2011/0024413 A1
(43) Pub. Date: Feb. 3, 2011

(54) Construct for Browning and Crisping a Food Item in a Microwave Oven

(76) Inventor: Lorin R. Cole, Larsen, WI (US)

Correspondence Address: WOMBLE CARLYLE SANDRIDGE & RICE, PLLC, ATTN: IP DOCKETING, P.O. BOX 7037, ATLANTA, GA, 30357-0037, US

(21) Appl. No.: 12/862,075

(22) Filed: Aug. 24, 2010

Related U.S. Application Data
(63) Continuation-in-part of application No. 12/560,695, filed on Sep. 16, 2009.
(60) Provisional application No. 61/192,251, filed on Sep. 17, 2008.

(51) Int. Cl. H05B 6/80; B65D 25/00

(52) U.S. Cl. 219/730; 220/62

(57) ABSTRACT

A carton comprises a microwave heating construct including a base and a plurality of upstanding walls defining an interior space for receiving a food item, and a cover joined to the construct along a line of disruption. The construct includes a line of disruption extending substantially across the base. The line of disruption defines a first section and a second section of the construct.

### CROSS-REFERENCE TO RELATED APPLICATIONS

This application is a continuation-in-part of U.S. patent application Ser. No. 12/560,695, filed Sep. 16, 2009, which claims the benefit of U.S. Provisional Application No. 61/192,251, filed Sep. 17, 2008, both of which are incorporated by reference herein in their entirety.

### TECHNICAL FIELD

This disclosure generally relates to constructs or apparatuses for heating or cooking a food item in a microwave oven. Cartons including such constructs or apparatuses are also disclosed. More particularly, this disclosure relates to various cartons and/or constructs for heating or cooking a food item in a microwave oven, where the food item has more than one item and/or surface intended to be browned and/or crisped.

### SUMMARY

This disclosure is directed generally to a construct or apparatus for preparing a food item in a microwave oven. The construct generally includes a heating surface capable of heating, browning, and/or crisping one or more components of a food item simultaneously. In one exemplary embodiment, the construct comprises a tray including a pair of sections that are capable of hinging towards one another along a line of disruption. The construct may be formed from a disposable material, for example, paperboard.

The construct may include a microwave energy interactive element that alters the effect of microwave energy on the adjacent food item. In one example, the microwave interactive element comprises a susceptor, i.e., a thin layer of microwave energy interactive material generally less than about 100 angstroms in thickness, for example, from about 60 to about 100 angstroms in thickness, and having an optical density of 0.15 to about 0.35, for example, about 0.17 to about 0.28. When exposed to microwave energy, the susceptor tends to absorb at least a portion of the microwave energy and convert it to thermal energy (i.e., heat) through resistive losses in the layer of microwave energy interactive material. The remaining microwave energy is either reflected by or transmitted through the susceptor. Susceptor elements (or susceptors) often are used to promote browning and/or crisping of the surface of a food item. However, other microwave energy interactive elements may be used.

The construct may be used to prepare various food items in a microwave oven, for example, sandwiches, savory or sweet pastries, breaded food items, or any other food item that desirably is heated, browned, and/or crisped.

If desired, the construct may comprise all or a portion of a carton for containing the food item prior to, during, and/or after heating.

Additional aspects, features, and advantages of the present invention will become apparent from the following description and accompanying figures.

### BRIEF DESCRIPTION OF THE DRAWINGS

The description refers to the accompanying drawings in which like reference characters refer to like parts throughout the several views, and in which:

FIG. 1A is a schematic perspective view of an exemplary microwave heating construct according to various aspects of the disclosure, in a fully open configuration;

FIG. 1B is a schematic perspective view of the microwave heating construct of FIG. 1A, in a partially closed configuration;

FIG. 1C is another schematic perspective view of the microwave heating construct of FIG. 1A, in a partially closed configuration;

FIG. 1D is a schematic perspective view of a portion of the microwave heating construct of FIGS. 1A-1C, separated into two parts;

FIG. 1E is a schematic top plan view of one side of a blank that may be used to form the microwave heating construct of FIGS. 1A-1C;

FIG. 1F is a schematic perspective view of the construct formed from the blank of FIG. 1E;

FIG. 2 is a schematic top plan view of one side of another exemplary blank that may be used to form a microwave heating construct;

FIG. 3A is a schematic perspective view of an exemplary carton including a microwave heating construct according to various aspects of the disclosure, in an open configuration;

FIG. 3B is a schematic perspective view of the exemplary microwave heating construct of FIG. 3A, in isolation; and

FIG. 3C is a schematic top plan view of an exemplary blank that may be used to form the carton of FIG. 3A.

### DESCRIPTION

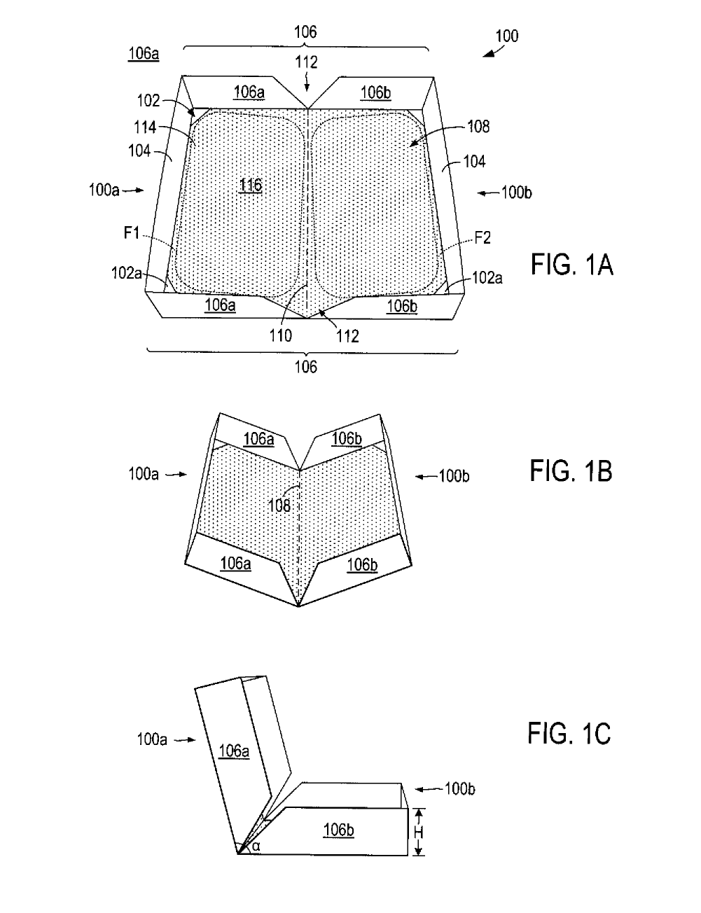

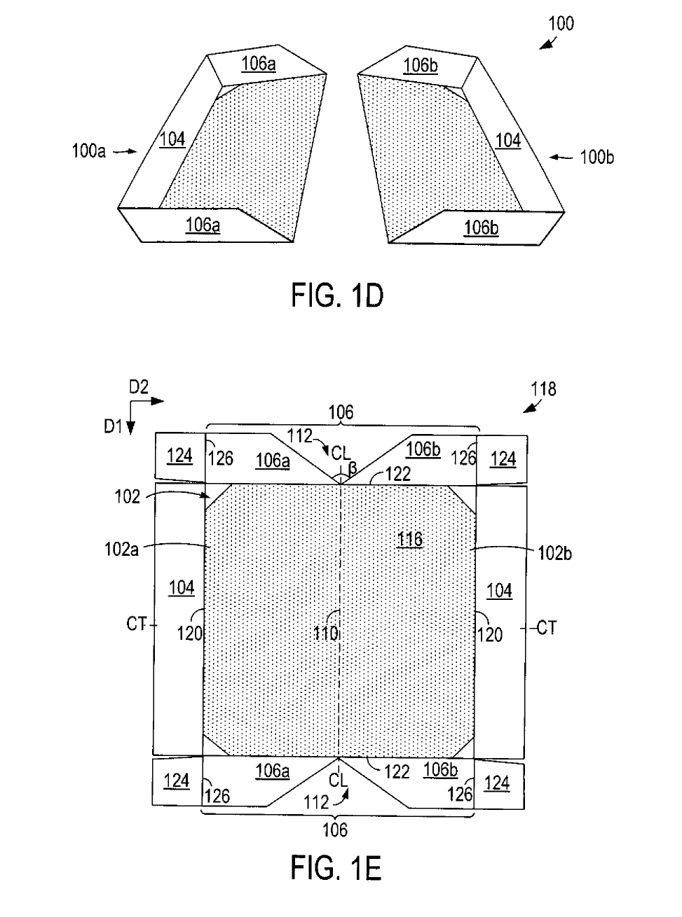

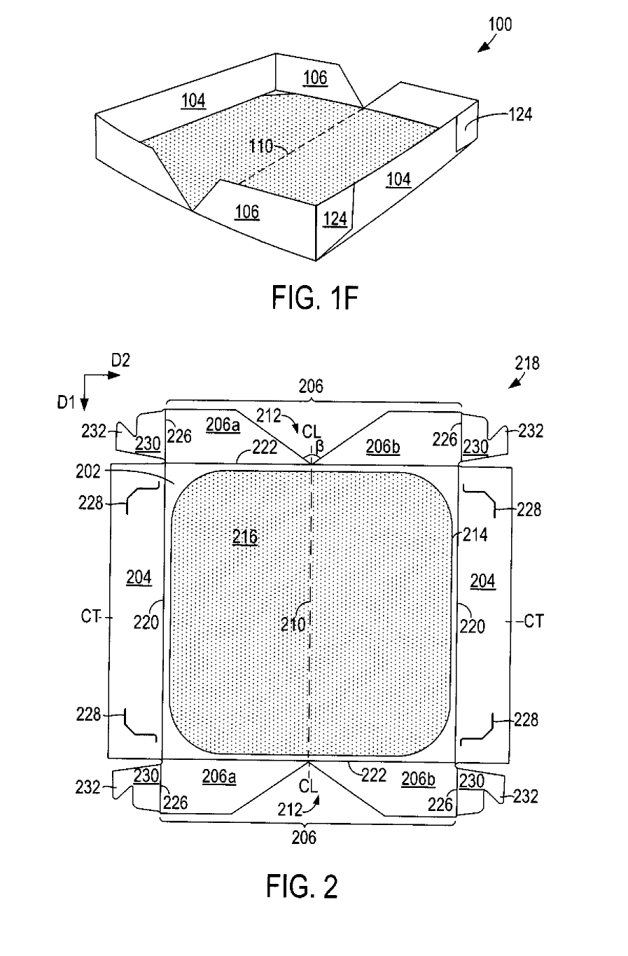

FIGS. 1A-1C schematically depict a microwave heating construct or apparatus 100 for heating, browning, and/or crisping a food item, for example, a sandwich, a breaded food item, or any other suitable food item. As shown in FIG. 1A, the construct generally comprises a tray 100 including a substantially planar base (or bottom panel) 102, a first pair of walls 104 opposite one another and a second pair of walls 106 opposite one another. The walls 104, 106 extend upwardly from a peripheral edge (e.g., outermost edge) of the base 102. The base 102 and walls 104, 106 define an interior space 108 for receiving one or more food items.

A line of disruption 110 extends substantially across the base 102 between the second pair of opposed walls 106. The line of disruption 110 defines a first section or portion 100a and a second section or portion 100b of the tray or construct 100, and a corresponding first section or portion 102a and second section or portion 102b of the base 102.

Each wall of the second pair of walls 106 includes a cutout or notch 112 substantially centered along the line of disruption 110. In this example, the notch 112 has a substantially triangular (e.g., inverted triangle) shape. However, other shapes are contemplated. The notch 112 divides each wall 106 into two sections 106a, 106b, with each section 106a, 106b of the wall being chamfered adjacent to the line of disruption 110, such that the height H of the chamfered portion of the wall decreases in a direction towards the line of disruption 110 (FIG. 1C).

As shown in FIGS. 1B and 1C, the line of disruption 110 may serve as a line of hinging (or hinge line) that allows the tray sections 100a, 100b to pivot toward one another (or to allow one section to pivot towards the other) to bring the construct 100 into a partially or substantially closed configuration. In this example, the chamfered portions of the walls 106 allow the sections 100a, 100b of the construct 100 to be brought into a substantially right (i.e., perpendicular) configuration without the respective wall sections 106 interfering with or engaging one another, such that an angle a between the sections 100a, 100b of the construct 100 may be about 90° (FIG. 1C), However, differently shaped notches may be used to allow different degrees of hinging, such that the angle a between construct portions 100a, 100b may be less than or greater than 90°.

If desired, a microwave energy interactive element 114 (shown schematically with stippling in FIGS. 1A-11D), for example, a susceptor, may overlie at least a portion of an interior side of the construct 100. The susceptor 114 may be supported on a polymer film 116 that at least partially defines an interior, food-contacting surface of the construct 100. In this example, the susceptor 114 substantially overlies the entire base 102 except for the corners, such that the susceptor 114 has a generally octagonal shape. However, other configurations of susceptors and/or other microwave energy interactive elements may be used, as will be discussed further below.

There are numerous possible ways to use the construct 100. In one example, the food item may have a pair of opposite sides, each of which is desirably browned and/or crisped. The food item may be separated into first and second parts F1, F2 (shown schematically with dashed lines in FIG. 1A), with the side of each part F1, F2 to be browned and/or crisped being positioned on the base 102 adjacent to the susceptor 114. By way of example, and not limitation, the food item may be a sandwich including two pieces of bread and a filling. The sandwich may be separated into a top portion F1 and bottom portion F2, each including a piece of bread, and placed on the first and second sections 102a, 102b of the base, and heated in an “open face” configuration, such that one side of each piece of bread is positioned adjacent to the susceptor 114.

Upon sufficient exposure to microwave energy, the susceptor 114 converts at least a portion of the microwave energy into thermal energy (i.e., heat), which then may be transferred to the adjacent food item to heat, brown, and/or crisp the surface of the food item (e.g., the bread).

When the heating cycle is complete, the food item may be re-assembled if needed or desired. For example, where the food item is heated in an open face configuration as described above, the construct 100 may be brought into a somewhat closed position by pivoting either or both sections 100a, 100b of the construct to cause the components of the food item (e.g., the sandwich) to be brought towards one another. The components then may be stacked on top of one another. Alternatively, the various components may be manually assembled to form a double faced sandwich.

If desired, the construct 100 may be separated into two pieces by tearing along line of disruption (e.g., tear line) 110 (FIG. 1D). One or both pieces may serve as a container for holding the food item as it is consumed. In this example, each section of the tray is substantially equal in size. However, other configurations are contemplated by the disclosure. By way of example and not limitation, one of the portions may be sized to have a larger base panel and/or higher side walls to better contain the assembled food item.

In another example, both the bread and the filling of a sandwich may be desirably browned and/or crisped. The filling, for example, a breaded meat item, may be placed on one section of the tray, while the bread is placed on the other. If desired, the user may be instructed to invert or “flip” one or both items during heating to brown and/or crisp the opposite side of the respective item. Additionally or alternatively, where the sandwich includes two pieces of bread (i.e., the sandwich is a double faced sandwich), the user may be instructed to replace the browned and/or crisped bread with the other piece, so that both pieces may be browned and/or crisped. Numerous other possibilities are contemplated.

FIG. 1E depicts a schematic top plan view of one side of an exemplary blank 118 that may be used to form the construct 100 of FIGS. 1A-1D. The blank 118 includes a plurality of panels joined along lines of weakening or disruption, for example, fold lines, tear lines, score lines, or any other lines of weakening or disruption, or any combination thereof. The blank 118 and each of the various panels generally has a first dimension, for example, a length, extending in a first direction, for example, a longitudinal direction, D1, and a second dimension, for example, a width, extending in a second direction, for example, a transverse direction, D2. It will be understood that such designations are made only for convenience and do not necessarily refer to or limit the manner in which the blank is manufactured or erected into the construct. The blank 118 may be symmetric or nearly symmetric about a transverse centerline CT and along a longitudinal centerline CL. Therefore, certain elements in the drawing figures may have similar or identical reference numerals to reflect the whole or partial symmetry.

As shown in FIG. 1E, the blank 118 includes a main panel 102 divided by a longitudinal line of disruption 110 into a first section or portion 102a and a second section or portion 102b. A pair of opposed side panels 104 is joined to the main panel 102 along respective longitudinal fold lines 120.

Likewise, a pair of opposed end panels 106 is joined to the main panel 102 along respective transverse fold lines 122, which may be substantially perpendicular to fold lines 120. The end panels 106 are generally rectangular shaped with a V-shaped (i.e., substantially triangular) notch or cutout 112 substantially centered along the longitudinal tear line 110. Each end panel 106 has a first section or portion 106a joined to the first section 102a of the main panel 102 and a second section or portion 106b joined to the second section 102b of the main panel 102, with the respective adjacent portions 106a, 106b being separated from one another by the notch 112. In each of various examples, an angle β between the notched edges of end panel portions 106a, 106b may be at least about 30°, at least about 40°, at least about 50°, at least about 60°, at least about 70°, at least about 80°, at least about 90°, at least about 100°, at least about 110°, at least about 120°, at least about 130°, at least about 140°, at least about 150°, at least about 160°, or at least about 170°. In one particular example, the edges are chamfered, such that the angle β is about 90°.

A pair of end flaps 124 is joined to the opposite transverse ends of each end panel 106 along respective longitudinal fold lines 126.

A microwave energy interactive element 114 (shown schematically with stippling in FIG. 1E), for example, a susceptor, may overlie all or a portion of any of the various panels of the blank 118. In this example, the microwave energy interactive element 114 has a substantially rectangular or square shape with chamfered corners. However, other configurations are contemplated. For example, in one exemplary embodiment, the susceptor overlies substantially all of one side of the blank 118. In still another exemplary embodiment, the susceptor overlies substantially all of one side of the blank, except the end flaps 124.

To form the construct 100 from the blank 118 according to one exemplary method, end flaps 124 may be folded inwardly toward the respective adjacent end panel 106 along longitudinal fold lines 126. The side panels 104 and end panels 106 may be folded along respective fold lines 120, 122 into a substantially upright position to form the walls 104, 106 of the construct or tray 100 (FIG. 1A). The end flaps 124 may be overlapped with and joined to the respectively adjacent portion of the side panels 104 to form the construct 100, as shown in FIG. 1F. The end flaps 124 may be joined to the side panels 104 in any suitable manner, for example, using adhesive bonding, mechanical fastening, thermal bonding, or any suitable combination thereof. Where adhesive bonding is used, the end flaps 124 may be referred to as “glue flaps”.

The construct may have any suitable dimensions, as needed for a particular microwave heating application. The particular dimensions may depend on the type of food item being heated, the desired heating time, the desired degree of browning and/or crisping, or any other suitable criteria.

FIG. 2 schematically depicts an exemplary variation of the blank 118 of FIG. 1E. The blank 218 of FIG. 2 includes features that are similar to the blank 118 shown in FIG. 1E, except for variations noted and variations that will be understood by those of skill in the art. For simplicity, the reference numerals of similar features are preceded in the figures with a “2” instead of a “1”.

In this example, the blank 218 is similar to the blank 118 of FIG. 1E, except that each side panel 204 includes a pair of somewhat S-shaped or zigzag shaped slits 228 proximate to the opposite longitudinal ends of the respective panel 204. Additionally, end flaps 124 a re replaced with locking flaps 230, each of which includes a locking projection 232 adapted to secure the respective locking flap 230 within the respectively adjacent receiving slit 228 in the side panel 204.

Further, in this example, the microwave energy interactive element 214, for example, the susceptor 214, has a substantially rectangular or square shape with rounded corners. Still other configurations are contemplated.

A construct formed from the blank 218 may be used in the manner described in connection with the construct 100 of FIGS. 1A-1D.

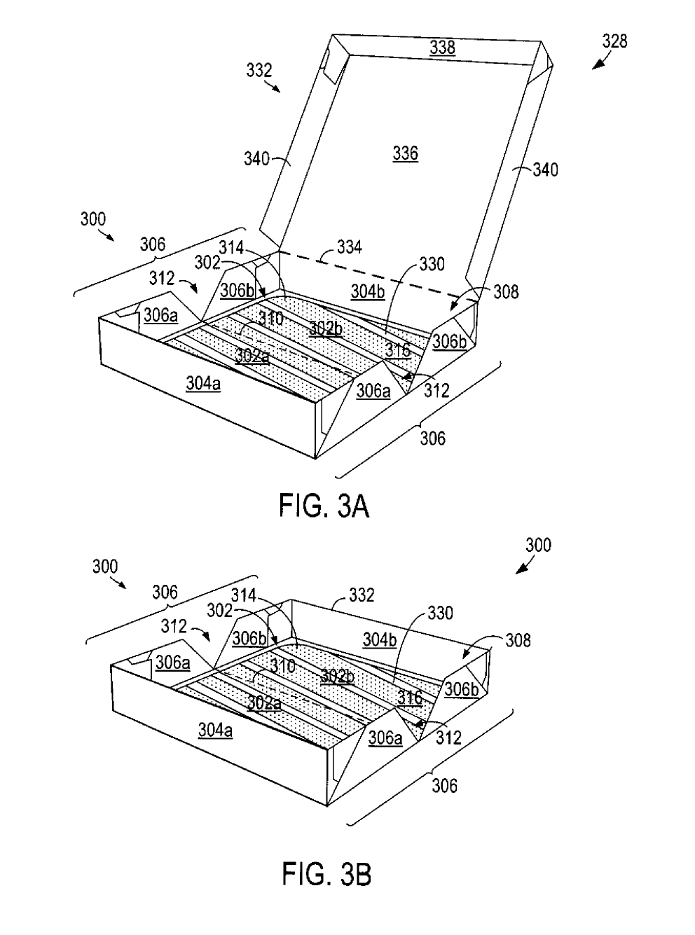

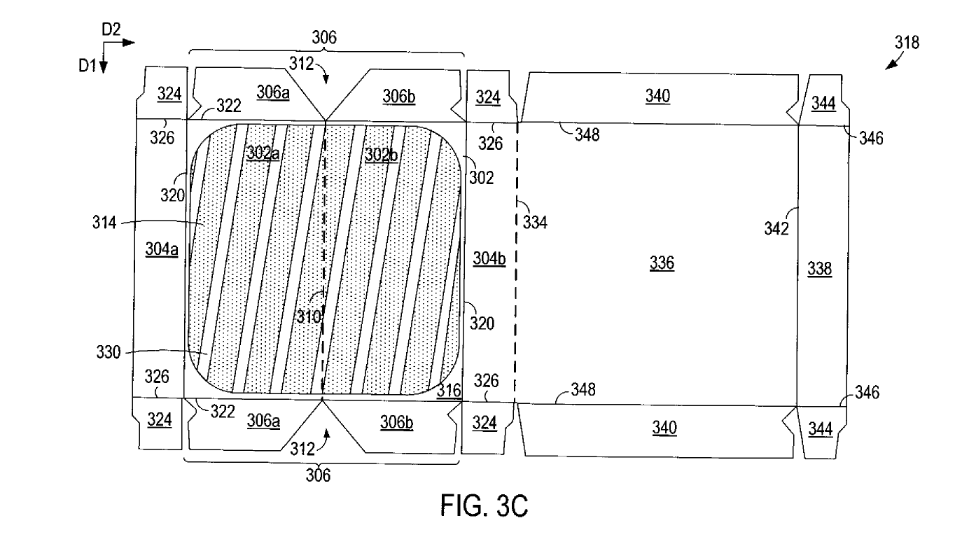

If desired, the construct may comprise all or a portion of a carton that may be used to contain the food item prior to heating. By way of example, and not limitation, FIG. 3A illustrates an exemplary carton 328 that includes (or can be transformed into) a construct 300 similar to the construct 100 of FIG. 1A. The construct 300 of FIG. 3A includes features that are similar to the construct 100 shown in FIG. 1A, except for variations noted and variations that will be understood by those of skill in the art. For simplicity, the reference numerals of similar features are preceded in the figures with a “3” instead of a “1”.

In this example, the microwave energy interactive element, for example, susceptor 314 (shown schematically with stippling), comprises a plurality of generally elongate microwave heating areas extending obliquely with respect to line of disruption 310. Microwave energy transparent areas 330 are disposed between adjacent microwave heating areas 314 such that the microwave energy transparent areas 330 and microwave energy interactive areas 314 are arranged in an alternating configuration. However, countless other configurations are contemplated.

As shown in FIG. 3A, the carton 328 includes a cover or lid 332 hingedly joined to the construct 300 along a line of disruption, for example, tear line 334. The cover 332 includes a top panel 336, a front cover panel 338, and a pair of side panels 340. When the carton 328 is in a closed configuration (not shown), the top panel 336 and the base panel 302 are in a superposed arrangement substantially parallel to one another, each pair of side panels 306, 340 are in a substantially facing, contacting relationship with one another, and the front cover panel 338 is in a substantially facing, contacting relationship with side panel 304a (or front wall panel 304a), as will be understood by those in the art. In the closed configuration, side panel 304b serves as a back panel (or back wall panel or wall) for the carton 328, panels 304a, 338 serve independently and cooperatively as a front wall for the construct 328, and each pair of panels 306, 340 serves as a respective side wall for the carton. However, other carton configurations are contemplated. To use the carton 328, the lid 332 may be separated from the construct 300 along tear line 334, as shown in FIG. 3B. The construct 300 may then be used as described above in connection with FIGS. 1A-1D. Alternately, the lid 332 may remain attached during the heating cycle.

Upon sufficient exposure to microwave energy, the susceptor areas 314 convert at least a portion of the impinging microwave energy to thermal energy, which then can be transferred to the surface of the adjacent food item to enhance browning and/or crisping. Less heat may be generated adjacent to the microwave energy transparent areas 330. As a result, the overall pattern of browning and/or crisping may resemble grill marks, such that the lighter and darker areas resemble the markings that may be obtained by heating a food item on a grill.

FIG. 3C schematically depicts an exemplary blank 318 for forming the carton 328 of FIG. 3A. The blank includes features that are similar to the blank 118 shown in FIG. 1E, except for variations noted and variations that will be understood by those of skill in the art. For simplicity, the reference numerals of similar features are preceded in the figures with a “3” instead of a “1”.

In the blank 318 of FIG. 3C, end flaps 324 are joined to side panels 304a, 304b along respective transverse lines of disruption, for example, fold lines 326.

Also, in this example, the microwave energy interactive element 314, for example, susceptor 314, has a substantially rectangular or square shape with rounded corners. Further, the blank 318 of FIG. 3C comprises a plurality of susceptor areas 314 arranged in an alternating manner with a plurality of microwave energy transparent areas 330. Alternatively, the microwave energy interactive element 314 may be thought of as a single susceptor or susceptor area interrupted by or circumscribing a plurality of microwave energy transparent areas 330. The microwave energy interactive and microwave energy transparent areas may have any suitable configuration and relative size depending on the heating, browning, and/or crisping needs for a particular application, as will be discussed further below.

The blank 318 also includes a top panel 336 joined to side panel 304b (or back panel or back wall panel) along a longitudinal line of disruption, for example, tear line 334. A front cover panel 338 is joined to the top panel 336 along a longitudinal line of disruption, for example, fold line 342, opposite and substantially parallel to line of disruption 334. A pair of end flaps 344 is joined to opposite longitudinal edges of the front cover panel 338 along respective transverse lines of disruption, for example, fold lines 346. A pair of side flaps 340 is joined to opposite transverse edges of the top panel 336 along respective transverse lines of disruption, for example, fold lines 348.

The carton 328 may be formed from the blank 318 according to various acceptable methods. To assemble the construct 300 according to one exemplary method, end flaps 324 may be folded inwardly toward the respective adjacent panel 304a, 304b along transverse fold lines 326. The side panels 304 and end panels 306 may be folded along respective fold lines 320, 322 into a substantially upright position to form the walls 304, 306 of the construct or tray 300 (FIG. 3A). The end flaps 324 may be overlapped with and joined to the respectively adjacent portion of the side panels 306 to form the construct 300, as shown in FIG. 3A. The end flaps 324 may be joined to the end panels 306 in any suitable manner, for example, using adhesive bonding, mechanical fastening, thermal bonding, or any suitable combination thereof. Where adhesive bonding is used, the end flaps 324 may be referred to as “glue flaps”.

To assemble the lid 332 according to one exemplary method, panels 338, 340 may be folded towards the top panel 336 along respective lines of disruption 342, 348. End flaps 344 may be folded towards panel 338 along respective lines of disruption 336. End flaps may be joined to the interior side or exterior side of panels 340. The top panel 336 may be folded towards the base or bottom panel 302 along lines of disruption 320, 334. If desired, the lid 332 may be adhered or otherwise affixed to the microwave heating construct 300.

Numerous other microwave heating constructs and cartons are encompassed by the disclosure. Any of such constructs or cartons may be formed from various materials, provided that the materials are substantially resistant to softening, scorching, combusting, or degrading at typical microwave oven heating temperatures, for example, at from about 250° F. to about 425° F. The materials may include microwave energy interactive materials, for example, those used to form susceptors (e.g., susceptors 114, 214, 314) and other microwave energy interactive elements, and microwave energy transparent or inactive materials, for example, those used to form the remainder of the construct or carton.

In the case of a susceptor, the microwave energy interactive material may comprise an electroconductive or semiconductive material, for example, a vacuum deposited metal or metal alloy, or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In other embodiments, the microwave energy interactive material may be carbon-based, for example, as disclosed in U.S. Pat. Nos. 4,943,456, 5,002,826, 5,118,747, and 5,410,135.

In still other embodiments, the microwave energy interactive material may interact with the magnetic portion of the electromagnetic energy in the microwave oven. Correctly chosen materials of this type can self-limit based on the loss of interaction when the Curie temperature of the material is reached. An example of such an interactive coating is described in U.S. Pat. No. 4,283,427.

Alternatively or additionally, the various microwave heating constructs (e.g., constructs 100, 300 and/or carton 328) may include other microwave energy interactive elements and/or structures. Structures including multiple susceptor layers are also contemplated.

By way of example, the construct may include a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements where the food item is prone to scorching or drying out during heating. In other cases, smaller microwave energy reflecting elements may be used to diffuse or lessen the intensity of microwave energy. One example of a material utilizing such microwave energy reflecting elements is commercially available from Graphic Packaging International, Inc. (Marietta, Ga.) under the trade name MicroRite® packaging material. In other examples, a plurality of microwave energy reflecting elements may be arranged to form a microwave energy distributing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may have any pattern, as needed to achieve the desired heating effect of the food item. For example, the microwave energy interactive material may be provided as a continuous or discontinuous layer or coating including circles, loops, hexagons, islands, squares, rectangles, octagons, and so forth.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

In the case of a susceptor, any of such discontinuities or apertures may comprise a physical aperture or void in one or more layers or materials used to form the structure or construct, or may be a non-physical “aperture”. A non-physical aperture is a microwave energy transparent area that allows microwave energy to pass through the structure without an actual void or hole cut through the structure. Such areas may be formed by simply not applying microwave energy interactive material to the particular area, by removing microwave energy interactive material from the particular area, or by mechanically deactivating the particular area (rendering the area electrically discontinuous). Alternatively, the areas may be formed by chemically deactivating the microwave energy interactive material in the particular area, thereby transforming the microwave energy interactive material in the area into a substance that is transparent to microwave energy (i.e., microwave energy inactive). While both physical and non-physical apertures allow the food item to be heated directly by the microwave energy, a physical aperture also provides a venting function to allow steam or other vapors or liquid released from the food item to be carried away from the food item.

By way of illustration, a microwave energy interactive element may include one or more transparent areas to effect dielectric heating of the food item. However, where the microwave energy interactive element comprises a susceptor, such apertures decrease the total microwave energy interactive area, and therefore, decrease the amount of microwave energy interactive material available for heating, browning, and/or crisping the surface of the food item. Thus, the relative amounts of microwave energy interactive areas and microwave energy transparent areas must be balanced to attain the desired overall heating characteristics for the particular food item.

As another example, one or more portions of a susceptor (e.g., susceptors 114, 214, 314) may be designed to be microwave energy transparent to ensure that the microwave energy is focused efficiently on the areas to be heated, browned, and/or crisped, rather than being lost to portions of the food item not intended to be browned and/or crisped or to the heating environment. By way of example, and not limitation, in the example illustrated in FIG. 2, the corners and peripheral margin of the base panel 202, and the entirety of the side panels 204, end panels 206, and locking flaps 230 may be microwave energy transparent where such areas are not likely to be in proximate or intimate contact with the primary areas of the food item intended to be browned and/or crisped. Countless other possibilities are contemplated.

Additionally or alternatively, it may be beneficial to create one or more discontinuities or inactive regions to prevent overheating or charring of the food item and/or the construct including the susceptor. By way of example, and not limitation, in the construct 100 illustrated in FIG. 1A, the end flaps 124 are in an overlapping relationship with the side panels 104. When exposed to microwave energy, the concentration of heat generated by the overlapped panels may be sufficient to cause the underlying support, in this case, paperboard, to become scorched. As such, the overlapping portions of one or both of panels or flaps 104, 124 may be designed to be microwave energy transparent, for example, using any of the methods described above (or any other suitable method). Countless other possibilities are contemplated.

As another example, the susceptor may incorporate one or more “fuse” elements that limit the propagation of cracks in the susceptor structure, and thereby control overheating, in areas of the susceptor structure where heat transfer to the food is low and the susceptor might tend to become too hot. The size and shape of the fuses may be varied as needed. Examples of susceptors including such fuses are provided, for example, in U.S. Pat. No. 5,412,187, U.S. Pat. No. 5,530,231, U.S. Patent Application Publication No. US 2008/0035634A1, published Feb. 14, 2008, and PCT Application Publication No. WO 2007/127371, published Nov. 8, 2007, each of which is incorporated by reference herein in its entirety. As stated above, the microwave energy interactive element may be supported on a microwave inactive or transparent substrate 116, 216, 316 for example, a polymer film or other suitable polymeric material, for ease of handling and/or to prevent contact between the microwave energy interactive material and the food item. The outermost surface of the polymer film may define at least a portion of the food-contacting surface of the package. Examples of polymer films that may be suitable include, but are not limited to, polyolefins, polyesters, polyamides, polyimides, polysulfones, polyether ketones, cellophanes, or any combination thereof In one particular example, the polymer film comprises polyethylene terephthalate. The thickness of the film generally may be from about 35 gauge to about 10 mil. In each of various examples, the thickness of the film may be from about 40 to about 80 gauge, from about 45 to about 50 gauge, about 48 gauge, or any other suitable thickness. Other non-conducting substrate materials such as paper and paper laminates, metal oxides, silicates, cellulosics, or any combination thereof, also may be used.

If desired, the polymer film may undergo one or more treatments to modify the surface prior to depositing the microwave energy interactive material onto the polymer film. By way of example, and not limitation, the polymer film may undergo a plasma treatment to modify the roughness of the surface of the polymer film. While not wishing to be bound by theory, it is believed that such surface treatments may provide a more uniform surface for receiving the microwave energy interactive material, which in turn, may increase the heat flux and maximum temperature of the resulting susceptor structure. Such treatments are discussed in U.S. patent application Ser. No. 12/709,578, filed Feb. 22, 2010, which is incorporated by reference herein in its entirety.

Various materials may be used as the base material for the blank, constructs, and cartons contemplated by this disclosure (to which any microwave energy interactive elements and/or polymer films may be joined adhesively or otherwise). For example, the base material may comprise paperboard having a basis weight of from about 60 to about 330 lb/ream, for example, from about 80 to about 140 lb/ream. The paperboard generally may have a thickness of from about 6 to about 30 mils, for example, from about 12 to about 28 mils. In one particular example, the paperboard has a thickness of about 14 mils. Any suitable paperboard may be used, for example, a solid bleached sulfate board, for example, Fortress® board, commercially available from International Paper Company, Memphis, Tenn., or solid unbleached sulfate board, such as SUS® board, commercially available from Graphic Packaging International, Marietta, Ga.

The carton or construct may be formed according to numerous processes known to those in the art, including using adhesive bonding, thermal bonding, ultrasonic bonding, mechanical stitching, or any other suitable process. Any of the various components used to form the package may be provided as a sheet of material, a roll of material, or a die cut material in the shape of the package to be formed (e.g., a blank).

It will be understood that with some combinations of elements and materials, the microwave energy interactive element may have a grey or silver color that is visually distinguishable from the substrate or the support. However, in some instances, it may be desirable to provide a package having a uniform color and/or appearance. Such a package may be more aesthetically pleasing to a consumer, particularly when the consumer is accustomed to packages or containers having certain visual attributes, for example, a solid color, a particular pattern, and so on. Thus, for example, the present disclosure contemplates using a silver or grey toned adhesive to join the microwave energy interactive element to the support, using a silver or grey toned support to mask the presence of the silver or grey toned microwave energy interactive element, using a dark toned substrate, for example, a black toned substrate, to conceal the presence of the silver or grey toned microwave energy interactive element, overprinting the metallized side of the polymer film with a silver or grey toned ink to obscure the color variation, printing the non-metallized side of the polymer film with a silver or grey ink or other concealing color in a suitable pattern or as a solid color layer to mask or conceal the presence of the microwave energy interactive element, or any other suitable technique or combination of techniques.

Although certain embodiments of this invention have been described with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is not intended nor is to be construed to limit the present invention or otherwise to exclude any such other embodiments, adaptations, variations, modifications, and equivalent arrangements of the present invention.

What is claimed is:

1. A carton comprising:
a microwave heating construct including a base and a plurality of upstanding walls defining an interior space for receiving a food item, the construct including
a microwave energy interactive material overlying at least a portion of the base, and
a line of disruption extending substantially across the base, the line of disruption defining a first section and a second section of the construct, each section of the construct including a portion of the base and at least one wall of the plurality of upstanding walls; and
a cover joined to the construct along a line of disruption, the cover being for overlying the interior space when the carton is in a closed configuration.

2. The carton of claim 1, wherein the cover is operative for being separated from the microwave heating construct along the line of disruption.

3. The construct of claim 1, wherein the walls of at least one of the first section and the second section include a chamfered portion adjacent to the line of disruption.

4. The construct of claim 1, wherein the walls of at least one of the first section and the second section include a portion that decreases in height towards the line of disruption.

5. The construct of claim 1, wherein the line of disruption substantially bisects the base.

6. The construct of claim 1, wherein the line of disruption serves as a hinge for pivoting the first section towards the second section.

7. The construct of claim 1, wherein
the line of disruption is a tear line; and
the first section and the second section are adapted to be separated from one another along the tear line.

8. The construct of claim 1, wherein the microwave energy interactive material further overlies at least a portion of the walls on a side of the walls facing the interior space.

9. The construct of claim 1, wherein the microwave energy interactive material has an optical density of from about 0.21 to about 0.28.

10. The construct of claim 1, wherein the microwave energy interactive material is operative for converting at least a portion of microwave energy to thermal energy.

11. A method comprising:
heating a food item within a carton, the food item having a first surface and a second surface to be browned and/or crisped, the first surface and the second surface being opposite one other, the carton including
a microwave heating construct including a base and a plurality of upstanding walls defining an interior space for receiving a food item,
a line of disruption extending substantially across the base, the line of disruption defining a first section and a second section of the construct, each section of the construct including a portion of the base and at least one wall of the plurality of upstanding walls, the food item being positioned on the base such that the first surface of the food item is seated on the first section of the construct and the second surface of the food item is positioned on the second section of the construct,
a microwave energy interactive material overlying at least a portion of the base, and
a cover joined to the construct along a line of disruption, the cover being for overlying the interior space when the carton is in a closed configuration.

12. The method of claim 11, further comprising separating the cover from the microwave heating construct along the line of disruption.

13. The method of claim 11, further comprising separating the food item into a first portion and a second portion, the first portion including the first surface and the second portion including the second surface.

14. The method of claim 13, wherein
the first portion of the food item is a top portion of the food item, and
the second portion of the food item is a bottom portion of the food item.

15. The method of claim 13, wherein
the first portion of the food item is an outer portion of the food item, and
the second portion of the food item is a filling.

16. The method of claim 13, further comprising exposing the food item on the construct to microwave energy.

17. The method of claim 16, wherein the microwave energy interactive material converts at least a portion of the microwave energy into thermal energy to brown and/or crisp the first surface and second surface of the food item.

18. The method of claim 13, further comprising pivoting at least one of the first section and the second section along the line of disruption to bring the first portion and the second portion of the food item together.

19. The method of claim 18, wherein the walls of at least one of the first section and the second section include a chamfered portion adjacent to the line of disruption.

20. The method of claim 13, wherein the line of disruption is a tear line, and the method further comprises separating the first section and the second section from one another along the tear line.

21. The method of claim 20, further comprising using at least one of the first section and the second section as a container for the food item.

22. A blank for forming a carton, comprising:
a plurality of adjoined panels, each of the adjoined panels having a first dimension extending in a first direction and a second dimension extending in a second direction substantially perpendicular to the first direction, the plurality of adjoined panels including
a bottom panel, the bottom panel including a line of disruption extending in the first direction, the line of disruption extending substantially between a pair of opposite edges of the bottom panel extending in the second direction, and
a first side panel and a second side panel foldably respectively joined to the opposite edges of the bottom panel, each of the first side panel and the second side panel including a notch adjacent to the line of disruption,
a back panel foldably joined to the bottom panel along an edge of the bottom panel extending in the first direction, and
a top panel foldably joined to the back panel along an edge of the back panel extending in the first direction; and
a microwave energy interactive material joined to the bottom panel, the microwave energy interactive material being operative for converting at least a portion of microwave energy into thermal energy.

23. The blank of claim 22, wherein the notch is substantially triangular in shape, such that the notch defines a pair of chamfered edges of the respective panel adjacent to the line of disruption.
